(19) United States
(12) Patent Application Publication
(10) Pub. No.: US 2007/0028236 A1
(43) Pub. Date: Feb. 1, 2007

(54) FILE TRANSFER SYSTEM

(75) Inventor: John David Williams II, Cumberland, ME (US)

Correspondence Address: VIERRA MAGEN MARCUS & DENIRO LLP, 575 MARKET STREET SUITE 2500, SAN FRANCISCO, CA, 94105, US

(73) Assignee: TYPEFI SYSTEM PTY LTD., Peregian Beach Qld (AU)

(21) Appl. No.: 11/459,786

(22) Filed: Jul. 25, 2006

(30) Foreign Application Priority Data
Jul. 27, 2005 (AU) 2005904020

(51) Int. Cl. G06F 9/445; G06F 9/44

(52) U.S. Cl. 717/178; 717/173

(57) ABSTRACT

A method of obtaining a file from a remote processing system via a browser application implemented using a processing system. The method includes causing the browser application to display an indication of available files, generate a download instruction in response to the selection of an available file and supply the download instruction to a file manager application. The file manager application is then used to generate a second download instruction using the download instruction and transfer the second download instruction to the remote processing system, the remote processing system being responsive to the second download instruction to transfer the selected file to the processing system.

### PRIORITY DATA

This application claims priority to Australian Provisional Patent Application No. 2005904020 filed Jul. 27, 2005.

### BACKGROUND OF THE INVENTION

The present invention relates to a method and apparatus for transferring files and in particular to allowing transfer of files to/from a remote computer using a Web page.

### DESCRIPTION OF THE PRIOR ART

The reference to any prior art in this specification is not, and should not be taken as, an acknowledgment or any form of suggestion that the prior art forms part of the common general knowledge.

When it is desired to download and modify a file from a remote location, this may be achieved in a number of manners. Thus, for example, a CVS (Concurrent Versions System) can be used to allow files from a remote network to be edited and updated. This is achieved by using an individual file history which allows updates to a file to be tracked. However, CVS suffers from a number of disadvantages and in particular generally is application specific so that it can only be used in certain circumstances.

Accordingly, attempts have been made to allow files to be downloaded and updated via Web pages. Typically however the download and upload process is browser application specific and can require significant interaction by the user. Thus, the user may be required to enter paths to which files are to be downloaded or uploaded, as well as to provide authentication information or the like.

Additionally, such systems do not always allow appropriate document tracking to be provided.

### SUMMARY OF THE PRESENT INVENTION

In a first broad form the present invention provides a method of obtaining a file from a remote processing system via a browser application implemented using a processing system, the method including, in the processing system:
a) causing the browser application to:
   i) display an indication of available files;
   ii) generate a download instruction in response to the selection of an available file;
   iii) supply the download instruction to a file manager application; and,
b) causing the file manager application to:
   i) generate a second download instruction using the download instruction; and
   ii) transfer the second download instruction to the remote processing system, the remote processing system being responsive to the second download instruction to transfer the selected file to the processing system.

In a second broad form the present invention provides apparatus for obtaining a file from a remote processing system via a browser application, the apparatus including a processing system having:
a) the browser application for:
   i) displaying an indication of available files;
   ii) generating a download instruction in response to the selection of an available file;
   iii) supplying the download instruction to a file manager application; and,
b) a file manager application for:
   i) generating a second download instruction using the download instruction; and
   ii) transferring the second download instruction to the remote processing system, the remote processing system being responsive to the second download instruction to transfer the selected file to the processing system.

Typically the method includes, in the processing system, causing the browser application to:
a) display a page including an internal frame; and,
b) submit the download instruction to the file manager application using the internal frame.

Typically the method includes, in the processing system, causing the browser application to:
a) transfer the download instruction to the remote processing system, the remote processing system being responsive to the download instruction to generate a response;
b) receive the response; and,
c) display the page using the response.

Typically the frame is a hidden internal frame.

Typically the download instruction includes at least one of:
a) an address of the file manager application;
b) an address of the file on the remote computer system; and,
c) authentication information.

Typically the method includes, in the processing system, causing the file manager application to:
a) determine, using the download instruction, the location of the file; and,
b) generate the second download instruction using the address of the file.

Typically the download instruction is in the form of a URL.

Typically the method includes, in the processing system, generating the URL using a Javascript executed in response to the selection of an available file.

In a third broad form the present invention provides a method of providing a file to a remote processing system via a browser application implemented using a processing system, the method including, in the processing system:
a) causing the browser application to:
   i) display an indication of uploadable files;
   ii) generate an upload instruction in response to the selection of an uploadable file;
   iii) supply the upload instruction to a file manager application; and,
b) causing the file manager application to:
   i) confirm the file is available for upload; and,
   ii) transfer the upload instruction and the file to the remote processing system, the remote processing system being responsive to the upload instruction to store the file.

In a fourth broad form the present invention provides apparatus for providing a file to a remote processing system via a browser application the apparatus including a processing system having:
a) the browser application for:
   i) displaying an indication of uploadable files;
   ii) generating an upload instruction in response to the selection of an uploadable file;
   iii) supplying the upload instruction to a file manager application; and,
b) a file manager application for:
   i) confirming the file is available for upload; and,
   ii) transferring the upload instruction and the file to the remote processing system, the remote processing system being responsive to the upload instruction to store the file.

Typically the method includes, in the processing system, causing the browser application to:
a) display a page including an internal frame; and,
b) submit the upload instruction to the file manager application using the internal frame.

Typically the frame is a hidden internal frame.

Typically the upload instruction includes at least one of:
a) an address of the file manager application;
b) an address of the file on the remote computer system; and,
c) authentication information.

Typically the upload instruction is in the form of a URL.

Typically the method includes, in the processing system, generating the URL using a Javascript executed in response to the selection of an uploadable file.

### BRIEF DESCRIPTION OF THE DRAWINGS

An example of the present invention will now be described with reference to the accompanying drawings, in which:—

FIG. 1 is a schematic of an example of apparatus for transferring a file;

FIG. 2 is a schematic of an example of the processing system of FIG. 1;

FIG. 3 is a schematic of an example of the end station of FIG. 1;

FIG. 4 is a flowchart of an example of a process for downloading a file from the base station of FIG. 1;

FIG. 5 is a flowchart of an example of a process for uploading a file to the base station of FIG. 1;

FIGS. 6A and 6B are a flowchart of an example of a process for “check-out” of a file from the base station of FIG. 1;

FIGS. 7A and 7B are a flowchart of an example of a process for “check-in” of a file to the base station of FIG. 1; and,

FIG. 8 is a flowchart of the process for adding a file to the base station of FIG. 1.

### DETAILED DESCRIPTION OF THE PREFERRED EMBODIMENTS

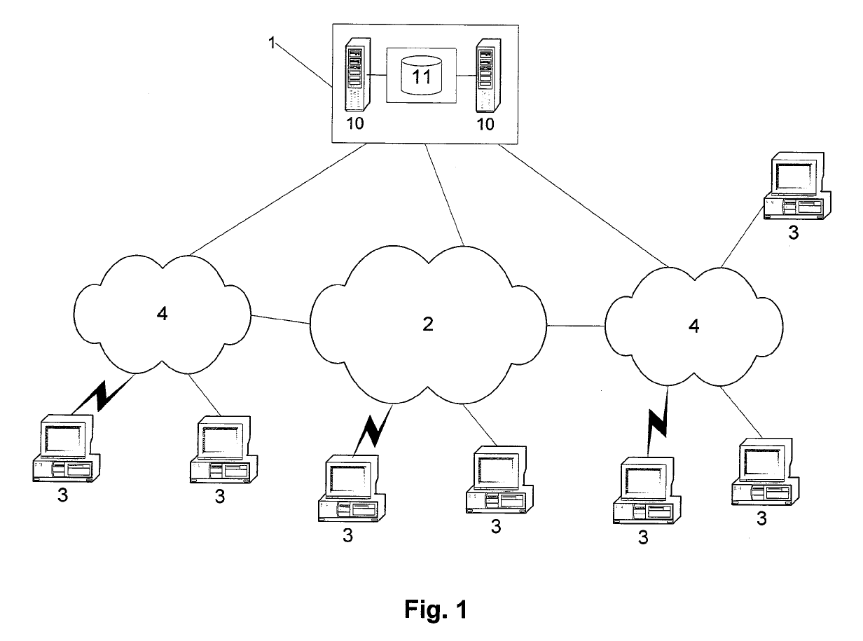

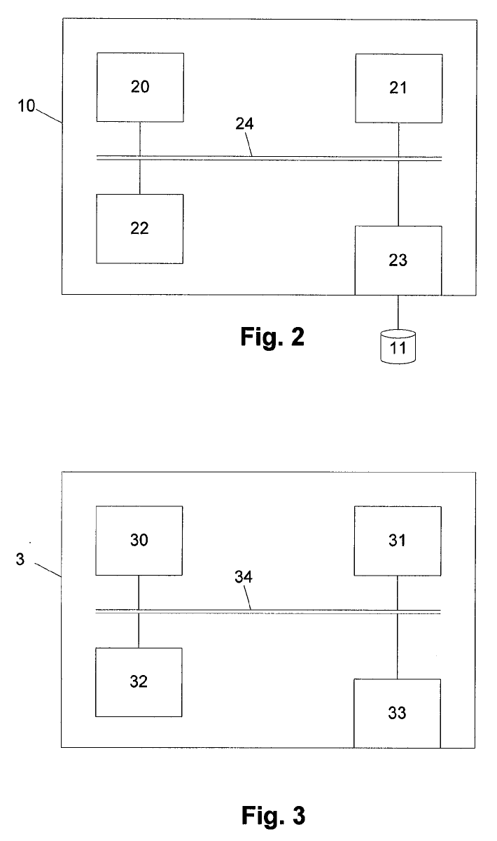

An example of a network architecture for allowing file transfer to/from a remote computer system is shown in FIG. 1.

As shown in this example the architecture includes a base station 1 coupled to a number of end stations 3, via communications networks 2, 4. The communications networks 2, 4 may be communications network such as the Internet, one or more Local Area Networks (LANs) one or more Wide Area Networks (WANs), Wireless Networks such as the GPRS Network, or the like. The base station 1 typically includes one or more processing systems 10, which may be coupled to a database 11, or the like, as shown.

In one example, the end stations 3 are adapted to communicate with the base station 1, utilising appropriate communications techniques, thereby allowing file transfer processes to be performed, and in particular to allow files to be downloaded from or uploaded to the base station 1. It will therefore be appreciated that the base station 1 and the end stations 3 may be of any suitable form.

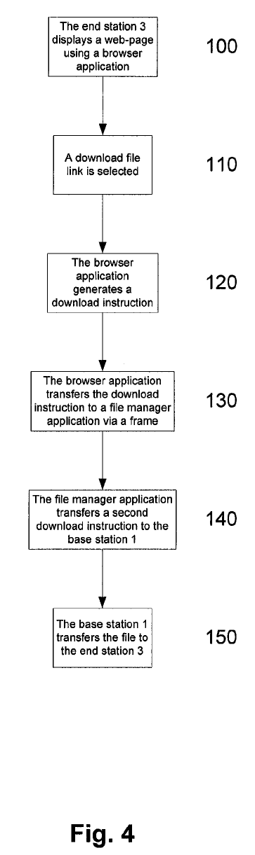

An example of a suitable processing system 10 is shown in FIG. 4. As shown the processing system 10 includes a processor 20, a memory 21, an input/output device 22, such as a keyboard and display or the like, and an external interface 23, coupled together via a bus 24. In use the external interface 23 may be coupled to the database 11, as well as providing connections to the communications networks 2, 4.

Accordingly, the processing system 10 may be any form of processing system, such as a computer server, a network server, a web server, a desktop computer, a lap-top or the like. Alternative specialised hardware may be used.

Similarly, the end stations 3 may be formed from a processor 30, a memory 31, an input/output device 32 and an external interface 33, coupled together via a bus 34. Again the external interface 33 may be used to provide a connection to the communications networks 2, 4.

Accordingly the end station 3 may be any form of computer system such as a desktop computer, lap-top, specialised hardware or the like.

In one example, the base station 1 and the end stations 3 communicate via the Internet 2, to allow a file to be selected, and then downloaded to the end station 3. The download process may be achieved through the use of a suitable Web pages hosted by the base station 1, and displayed on the end station 3 using a suitable browser application, such as Internet Explorer by Microsoft Corp. USA.

In this case, a user of the end station 3 will view the Web page using the browser application and select a link to the file to be downloaded. Following this, a file manager application hosted by the end station 3 communicates with the base station 1 to allow the file to be downloaded substantially automatically. This therefore allows users of the end stations 3 to access files stored in the database 11, or at other locations.

A similar process can be used to upload files to the base station 1, again allowing users of the end stations 3 to store files in the database 11.

An example of a process for downloading a file from a remote location will now be described with reference to FIG. 4.

At step 100 the end station 3 displays a Web page using the browser application. The user selects a download file link, such as a hyperlink, provided on the Web page at step 110. The selection of the link causes the browser application to generate a download instruction at step 120.

This may be initiated in any one of a number of ways, such as through the use of appropriate Javascripts, or the like, as will be described in more detail below. The download instruction typically includes information required to coordinate the download and may include for example an indication of a location in which the file is stored, or the like, as will be described in more detail below.

At step 130, the browser application transfers the download instruction to the file manager application. This is typically achieved by having the download instruction loaded into an internal frame within the Web page, which causes the browser application to initiate a connection and hence forward the download instruction to the file manager application.

At step 140 the file manager application generates a second download instruction based on the download instruction received from the browser application, and transfers this to the base station 1. This in turn causes the base station 1 to transfer the file to the end station 3, and in particular allows the base station 1 to supply the file to a predetermined location indicated by the download instruction.

Accordingly, in this example, the system is configured to allow the browser application to transfer a download instruction to the file manager application using an internal frame within the Web page. This in turn allows the file manager application to coordinate the file transfer with the base station 1, thereby obviating the need for input from the user, or for the use of a download protocol which is browser application specific. This therefore allows single click file download to be achieved using any browser application.

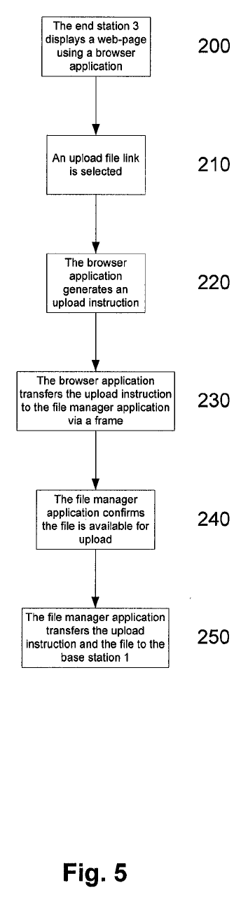

An example of an upload process will now be described with reference to FIG. 5.

In this example, at step 200, the end station 3 displays a Web page using the browser application. At step 210 an upload file link is selected by the user, which in turn causes the browser application to generate an upload instruction at step 220. At step 230, the upload instruction is transferred to the file manager application by the browser application, via an internal frame within the presented Web page.

At step 240 the file manager application confirms the file is available for upload, before transferring the upload instruction and the file to the base station 1, thereby allowing the base station 1 to store the file in the database 11, or the like.

In general the download and upload of files may be achieved in a variety of manners.

For example, a “check-out” process can be used, in which case the base station 1 updates a record relating to the file indicating that the file is “checked-out” to a specific user, thereby preventing the file being updated by third parties.

In this example, if the user updates the file, the file can be uploaded to the base station 1 in a “check-in” process, with the file copy stored on the base station 1 being updated in accordance with any changes made by the user. This “check-in” process allows a user to download a file using a single click, update the file, and then return the updated file to the base station 1 using another single click.

Alternatively, files may be opened from a remote location, in which case, the copy of the file on the user end station 3 is a second copy of the file that can be updated independently of the copy on the base station 1. Similarly, new files can be added to the base station 1 using an alternative procedure.

It will therefore be appreciated that this provides a mechanism to allow files to be easily transferred between an end station 3 and a remote processing system such as the base station 1. By utilisation of a file manager application, and appropriate communications protocols, this allows the process to be performed using a single click regardless of the browser application used, whilst still allowing version tracking to be performed.

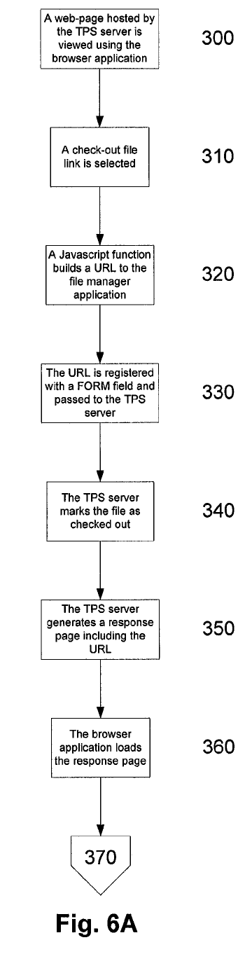

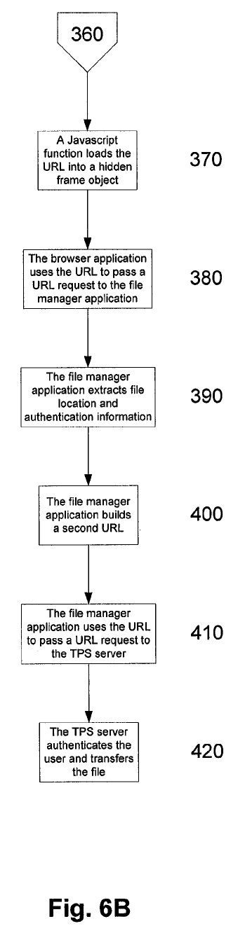

An example of the “check-out” process will now be described in more detail with reference to FIGS. 6A and 6B. In this example, it is assumed that the base station 1 implements a TPS server.

Accordingly, at step 300 the end station 3 is used to display a Web page hosted by the TPS server. The Web page is viewed using the browser application executed by the end station 3, such as Internet Explorer™, Mozilla, Firefox, or the like.

At step 310 a user selects a “check-out” file link, with the selection of the link causing a Javascript function to build a download instruction. The download instruction may be in any one of a number of forms, but in this example is in the form of a URL that is used to instruct the file manager application to download the selected file and to instruct the TPS server to “check-out” the file to the user of the end station 3.

An example URL is as follows:

http://localhost:8472/d/MyProject/Content/ContFile.doc?h=tpsserver:8080&open=true&fmuid=93jadc7ef

where:

http://localhost:8472—base URL of local FileManager
/d—Download command
/MyProject/Content/ContentFile.doc—path to file to download on server
h=tpsserver:8080—URL of TPS Server
open=true—Open the file after downloading
fmuid=93jadc7ef—Encrypted user credentials

Thus, the URL includes at least an address of the file manager application on the end station 3, as well the address of the relevant file on the base station 1. In addition to this, the URL also typically includes any user credentials required to authenticate the user and approve the file download.

At step 330 the URL is registered with a FORM field forming part of the HTML file defining the Web page displayed by the browser application. The URL is registered as a post-processing action and is passed to the TPS server.

At step 340 the TPS server receives the FORM POST submission and marks the file as “checked-out” by modifying a check state parameter stored in the database 11. This is typically achieved by providing an indication of the user's details, for example as determined from the authentication information forming part of the URL. This allows the user to which the file is “checked-out” to be recorded. If additional information is recorded, such as a time stamp or the like, this in turn allows an audit trail of file revision to be maintained.

Once the check state parameter has been updated, the TPS server generates a response including the URL at step 350. The response is transferred to the browser application, and causes the browser application to load a response page at step 360.

The response page includes an internal frame object inside the Web page that has zero associated pixels, and consequently is hidden from the user. The loading of response page causes a Javascript function to load the URL into the hidden internal frame object at step 370.

The loading of the URL causes the browser application to initiate a new connection using the URL, and a manner similar to having the browser application load a new Web page using a normal URL. However, this is performed with respect to the internal frame alone, which has two main implications. Firstly, as the internal frame is hidden from the user, the user is not aware of the action. Secondly, the use of the internal frame, allows the connection request to be made to an entity other than the TPS server.

Accordingly, in this example, the URL, as it include the file manager application address, causes the browser application to initiate a connection with the file manager application by passing a URL request to the file manager application at step 380. The URL request is therefore effectively a request for a connection between the hidden internal frame and file manager based on the URL.

At step 390 the file manager application extracts file location and authentication information from the URL and operates to build a second URL to the file at step 400. At step 410 the file manager application uses the second URL to pass a URL request to the TPS server, with the TPS server using the received second URL to authenticate the user at step 420. This is performed in accordance with standard techniques based on the user credentials outlined above. Once the user has been authenticated, this allows the TPS server to transfer the file to the file manager application.

The file is then available on the end station 3, allowing the user to review and edit a local copy of the file as required.

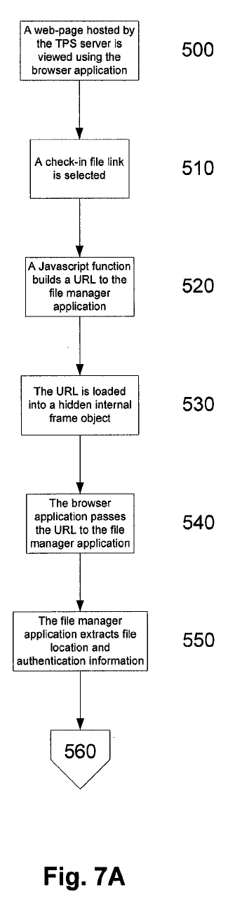

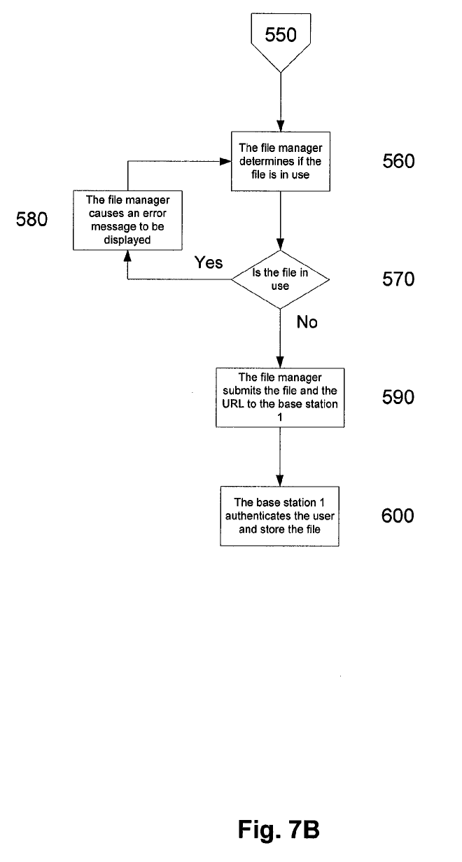

Once review and/or editing has been completed, the “check-in” process can be used to allow the file to be returned to the base station 1, allowing the updated file to be made available to third parties. This process will now be described with reference to FIGS. 7A and 7B.

In particular, at step 500 a Web page hosted by the TPS server is viewed using the browser application. At step 510 the user selects a “check-in” file link, with the selection of this link causing a Javascript function to build an upload instruction in the form of a URL to the file manager application at step 520.

An example of the URL structure is as set out below:

http://localhost:8472/u/MyProject/Content/ContFile.doc?h=tpsserver:8080&checkin=true&fmuid=93jadc7ef

where:

http://localhost:8472—base URL of local FileManager
/u—Download command
/MyProject/Content/ContentFile.doc—path to file to download on server
h=tpsserver:8080—URL of TPS Server
checkin=true—Open the file after downloading
fmuid=93jadc7ef—Encrypted user credentials

Thus, the URL again includes at least an address of the file manager application on the end station 3, as well the address of the relevant file on the base station 1. In addition to this, the URL also typically includes any user credentials required to authenticate the user and approve the file download.

At step 530 the browser application will cause the URL to be loaded into an internal frame object within the Web page, which is again typically hidden by having a zero pixel associated size. The provision of the URL to the frame object causes the browser application to pass a URL request, including the URL, to the file manager application at step 540.

At step 550 the file manager application extracts the file location and authentication information from the URL, and uses this to determine the files selected for “check-in”.

At step 560 the file manager determines if the file is in use and if so the process moves on at step 570 allowing the file manager to cause an error message to be displayed to the user at step 580. This may be achieved in a number of manners, and in one example is achieved by having the FileManager build an error message and sends this as a URL to the TPS Server.

An example URL is shown below:

http://tpsserver:8080/msg?users=userid&subject=Upload%2FFailed&msg=Fle%/2FIn%/2FUse

The TPS Server receives the URL, and queues a message for the specified user. Periodically (currently every 5 secs), the user's browser application will check for new messages, and consequently display an error message to the user using a Javascript function. An empty response is returned to the browser. This allows the user to close the file, allowing the process to continue.

It will be noted that the manner in which the file manager checks to determine if the file is open will depend on the operating system. Thus, for example, in Windows™ this is achieved by testing if the file can be opened for editing. If not, then it is assumed that the file is in use. On Macintosh operating systems, this can be achieved by issuing an operating system command to see if any application has the file open.

The process can then return to step 560 allowing the user to close the file, which in turn allows the file manager again assess if the file is in use.

Once it is determined that the file is not in use at step 570 the process moves to step 590 at which point the file manager submits the file and the URL to the base station 1. At step 600, the base station 1 operates to authenticate the user credentials contained within the URL and store the file in an appropriate location as indicated in the URL.

The base station will also typically check to determine if the check state parameter indicates the file is “checked-out”, and if so, modifies the parameter to indicate that the file is no longer “checked-out”.

Accordingly, the above described processes allow a file to be downloaded by a single click on an appropriate link. In this instance, the file manager application is provided with a URL allowing it to communicate with the TSP server to coordinate the file check-out. This is achieved using a hidden frame object provided in the Web page presented in by the browser, thereby ensuring the URL can be transferred to the file manager application irrespective of the browser application being used. The check-in process can also be implemented in a similar manner.

A consequence of this is that a single link can be used for both check-in and check-out of a file. In this instance, when a file is not currently checked-out, selection of the link to the file by a single click can cause the file to be downloaded from the base station 1 to the end station 3. In the event that the file is currently checked-out to the respective user, then a single click on the link can cause the file to be checked-in.

Thus, it will be appreciated that this can be used to provide single click interactivity for file check-in/check-out regardless of the browser application being utilised.

In addition to providing check-in and check-out of files, it is also possible to open or add files.

Thus, in the event in which a file is already checked-out, or if it is not desired to check a file out for updating, it is alternatively possible to simply open a copy of the file. The file open process is substantially similar to the “check-out” process described above with respect to FIGS. 6A and 6B, except that the file is assumed to already be “checked-out”. Accordingly, the file is downloaded to the user's end station 3, and the TPS server does not make any alternation to the check state parameter.

In the case of uploading new files, or adding files to the system, a slight modification of the “check-in” procedure is required.

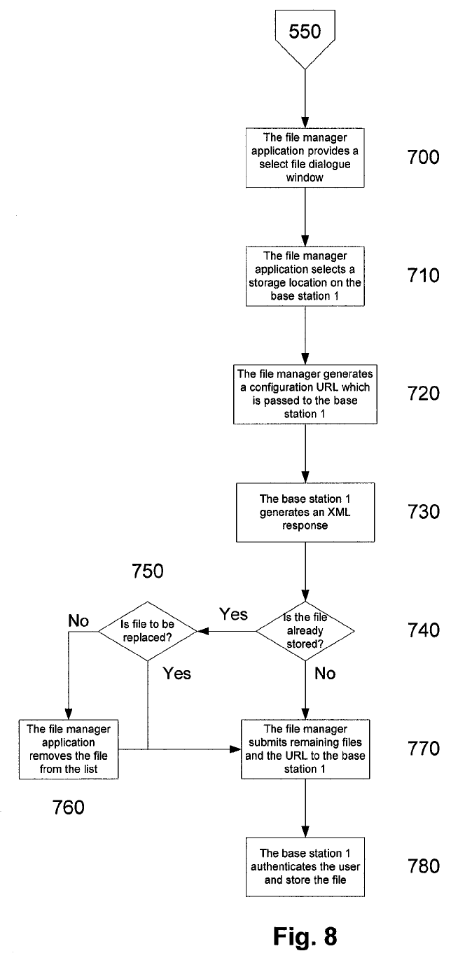

In this instance, the process follows steps 500 to 550 from the above described check-in process. The additional steps performed are then as set out in FIG. 8.

Thus, at step 700, the file manager application generates a select file dialogue window allowing the user to select files to be added to the base station 1. At step 710, the file manager selects a storage location on the base station 1, before generating a preliminary URL at step 720.

The preliminary URL is supplied with details of the files to be added to the base station 1, allowing the base station 1 to determine if files having the same file name currently exist, and generate a corresponding XML response at step 730.

At step 740, the file manager application uses the response to determine if the selected files already exist on the base station 1, and if so, the file manager application determines if the file on the base station 1 is to be replaced at step 750. This may be achieved using a suitable warning, generated for example by using an appropriate Javascript command, in a manner similar to that described above with respect to steps 560 to 580.

If the file is not to be replaced, the file manager application removes the file from a list of files to be uploaded at step 760.

Once the files selected for adding have been updated as required, the file manager submits the URL to the base station 1 at step 770, which then operates to authenticate the user and store the files at step 780, in manner similar to that described above with respect to steps 590 and 600.

It will be appreciated that whilst the above process has been described with respect to We pages, this could apply to any environment in which files are transferred between processing systems via a computer network, and could therefore apply to any form of display page, such as an intranet page, Internet page, or the like.

Persons skilled in the art will appreciate that numerous variations and modifications will become apparent. All such variations and modifications which become apparent to persons skilled in the art, should be considered to fall within the spirit and scope that the invention broadly appearing before described.

1) A method of obtaining a file from a remote processing system via a browser application implemented using a processing system, the method including, in the processing system:
(a) causing the browser application to:
(i) display an indication of available files;
(ii) generate a download instruction in response to the selection of an available file;
(iii) supply the download instruction to a file manager application; and,
(b) causing the file manager application to:
(i) generate a second download instruction using the download instruction; and
(ii) transfer the second download instruction to the remote processing system, the remote processing system being responsive to the second download instruction to transfer the selected file to the processing system.

2) A method according to claim 1, wherein the method includes, in the processing system, causing the browser application to:
(a) display a page including an internal frame; and,
(b) submit the download instruction to the file manager application using the internal frame.

3) A method according to claim 2, wherein the method includes, in the processing system, causing the browser application to:
(a) transfer the download instruction to the remote processing system, the remote processing system being responsive to the download instruction to generate a response;
(b) receive the response; and,
(c) display the page using the response.

4) A method according to claim 2, wherein the frame is a hidden internal frame.

5) A method according to claim 1, wherein the download instruction includes at least one of:
(a) an address of the file manager application;
(b) an address of the file on the remote computer system; and,
(c) authentication information.

6) A method according to claim 5, wherein the method includes, in the processing system, causing the file manager application to:
(a) determine, using the download instruction, the location of the file; and,
(b) generate the second download instruction using the address of the file.

7) A method according to claim 1, wherein the download instruction is in the form of a URL.

8) A method according to claim 7, wherein the method includes, in the processing system, generating the URL using a Javascript executed in response to the selection of an available file.

9) A method of providing a file to a remote processing system via a browser application implemented using a processing system, the method including, in the processing system:
(a) causing the browser application to:
(i) display an indication of uploadable files;
(ii) generate an upload instruction in response to the selection of an uploadable file;
(iii) supply the upload instruction to a file manager application; and,
(b) causing the file manager application to:
(i) confirm the file is available for upload; and,
(ii) transfer the upload instruction and the file to the remote processing system, the remote processing system being responsive to the upload instruction to store the file.

10) A method according to claim 9, wherein the method includes, in the processing system, causing the browser application to:
(a) display a page including an internal frame; and,
(b) submit the upload instruction to the file manager application using the internal frame.

11) A method according to claim 10, wherein the frame is a hidden internal frame.

12) A method according to claim 9, wherein the upload instruction includes at least one of:
(a) an address of the file manager application;
(b) an address of the file on the remote computer system; and,
(c) authentication information.

13) A method according to claim 9, wherein the upload instruction is in the form of a URL.

14) A method according to claim 13, wherein the method includes, in the processing system, generating the URL using a Javascript executed in response to the selection of an uploadable file.

15) Apparatus for obtaining a file from a remote processing system, the apparatus including a processing system implementing a browser application, the processing system being for:
(a) causing the browser application to:
(i) display an indication of available files;
(ii) generate a download instruction in response to the selection of an available file;
(iii) supply the download instruction to a file manager application; and,
(b) causing the file manager application to:
(i) generate a second download instruction using the download instruction; and
(ii) transfer the second download instruction to the remote processing system, the remote processing system being responsive to the second download instruction to transfer the selected file to the processing system.

16) A computer program product for obtaining a file from a remote processing system, the computer program product including computer executable code which when executed on a suitable processing system implementing a browser application:
(a) causes the browser application to:
(i) display an indication of available files;
(ii) generate a download instruction in response to the selection of an available file;
(iii) supply the download instruction to a file manager application; and,
(b) causes the file manager application to:
(i) generate a second download instruction using the download instruction; and
(ii) transfer the second download instruction to the remote processing system, the remote processing system being responsive to the second download instruction to transfer the selected file to the processing system.

17) Apparatus for providing a file to a remote processing system via a browser application implemented using a processing system, the apparatus including a processing system for:
(a) causing the browser application to:
(i) display an indication of uploadable files;
(ii) generate an upload instruction in response to the selection of an uploadable file;
(iii) supply the upload instruction to a file manager application; and,
(b) causing the file manager application to:
(i) confirm the file is available for upload; and,
(ii) transfer the upload instruction and the file to the remote processing system, the remote processing system being responsive to the upload instruction to store the file.

18) A computer program product for providing a file to a remote processing system, the computer program product including computer executable code which when executed on a suitable processing system implementing a browser application:
(a) causes the browser application to:
(i) display an indication of uploadable files;
(ii) generate an upload instruction in response to the selection of an uploadable file;
(iii) supply the upload instruction to a file manager application; and,
(b) causes the file manager application to:
(i) confirm the file is available for upload; and,
(ii) transfer the upload instruction and the file to the remote processing system, the remote processing system being responsive to the upload instruction to store the file.
